(19) United States
(12) Patent Application Publication
(10) Pub. No.: US 2003/0233429 A1
(43) Pub. Date: Dec. 18, 2003

(54) Method and apparatus for programming and controlling an environment management system

(76) Inventors: Pierre Matte, Sainte-Foy (CA); Francois Zacharie, Franklin (CA)

Correspondence Address: Ogilvy Renault, 1600-1981 McGill College Avenue, Montreal, QC, H3A 2Y3, CA

(21) Appl. No.: 10/158,590

(22) Filed: May 31, 2002

(51) Int. Cl. G06F 15/16; G06F 15/173; G06F 15/177

(52) U.S. Cl. 709/221; 709/223; 709/229; 340/5.5; 340/541

(57) ABSTRACT

An access terminal is provided for creating and modifying parameter values controlling an environment management system. The access terminal is in communication with a server for gathering and storing programming data according to the input parameter values and for associating stored programming data with an identification code. A receiver module connects to the server and requests download of the stored programming data when it receives a download request from an environment management system controller. A triggering means in communication with a system controller is provided for authenticating a user and triggering programming data download. A method of bi-directional communication between the environment management system controller and the receiver module is provided. Receiver module is able to relay environment alarm status information contained in the message to an alarm management module and is able to retrieve from a server the updated control parameters for programming and controlling the environment management system.

### FIELD OF THE INVENTION

The invention relates to remotely monitoring, programming and controlling environment management systems, such as home security systems and/or home automation systems.

### BACKGROUND OF THE INVENTION

In any residential environment, there are many stand-alone devices and a few individual systems functioning independently. In order to increase environmental comfort and efficiency, the trend for the future is towards centralized home automation, that is, combining all devices and systems into a comprehensive automated environment management system. Such management systems enhance the homeowner's lifestyle by making the environment more comfortable, safer and more efficient. Commonly, such systems provide features allowing for control of lighting, entertainment, security, telecommunications, heating and air conditioning appliances.

Home automation is currently conveniently implemented through communication protocols, such as X10, that allow for remote control of electrical devices. X10 implements an easy-to-use, low cost and modular home automation system, comprising transmitter and receiver modules, as well as various sensors. Since the modules take advantage of the existing power line connections, no additional wiring is needed and no professional installation is required. The system has a central controller module, providing programming and control options for all devices connected to it. Currently there is a wide range of controllers available, from simple plug-in devices-to remote controls, security panels, telephone controllers and computer programmable panels. The central controller module allows the user to program sequences of events to occur in response to both direct input signals, from a sensor or a pushbutton, as well as scheduled events. The controller therefore ensures all communication between the various connected devices and provides a common interface for the user. As more devices are added to the system, the controller's task becomes more complex, as it must provide increased functionality through the same interface. The interface however cannot be easily modified, and in most cases, a complete replacement of the controller module is needed.

Current systems provide a numeric keypad control panel as an interface to the environment management system. Such an interface requires the user to enter numeric keypad sequences corresponding to various functions and settings of the system. By entering these sequences of numbers, the user navigates through a hierarchy of menus whose organization is not intuitive. Most often, the numeric keypad sequences are randomly chosen and therefore difficult to remember. Since the mapping between the controls and their intended actions is not clear, users are more prone to making mistakes. Furthermore, the only feedback provided by the control panel is auditory, making it difficult to distinguish between different error messages. Such systems are intimidating for novice users and are hard to learn and use.

Some systems attempt to solve the user interface problem by integrating a display screen to the control panel. However, this solution increases the overall cost of the system.

Furthermore, control panels currently providing programming and controlling abilities to any environment management system run software that becomes obsolete as new features and functionality must be supported. Currently, the upgrade of the controller software must be done manually, either by a professional installer or by the user, with the upgrade software to be purchased from the manufacturer. Such methods are inconvenient, difficult and also, more expensive, for the homeowner.

### SUMMARY OF THE INVENTION

An object of the present invention is that of providing a system for remotely programming and controlling an environment management system offering a convenient way of upgrading the software running on the environment control system.

Another object of the present invention is that of providing a method for remotely monitoring an environment management system which can broadcast messages to a multitude of users.

Accordingly, an object of the present invention is to provide a system for controlling and programming an environment control system, offering the advantages of a graphical user interface or other user-friendly interface, without the added cost of integrating a display screen to the control panel.

Another object of the present invention is to provide a system for controlling and programming an environment control system offering the advantage of having an updateable user interface, that can be easily modified to include new features and functionality.

An object of the present invention is that to provide a system for controlling and programming an environment management system, including an access terminal for creating and modifying parameter values controlling the environment management system and a server for gathering and storing the parameter values as programming data, associated with an identification code, in the same communication session. The system further provides the ability, in a different communication session, of a receiver module transmitting the programming data from the server to the environment management system, following a request for download, activated by a triggering means at the environment management system controller.

In a broad aspect of the present invention, the Internet, more precisely the World Wide Web provides an interactive medium for gathering valid user input and for displaying control parameter information in a visual manner in a web browser. Furthermore, the number of errors is reduced since the user is restrained in inputting information by the type of fields available. Such an interface makes the system easy to learn and use and more accessible to users of all backgrounds.

According to another broad aspect of the invention, the Web provides the possibility of easily changing an HTML-based interface in order to accommodate new functionality of the system. Such a Web-based interface is a low cost solution to the problem of changing the environment control system device as its interface becomes obsolete.

According to another braod aspect of the invention, an access terminal is provided to a user for creating and modifying parameter values controlling an environment management system. The access terminal is in communication with a server for gathering and storing programming data according to the input parameter values and for associating stored programming data with an identification code. A receiver module may connect to the server and request download of the stored programming data when it receives a download request from an environment management system controller. A triggering means in communication with an environment management system controller is provided for authenticating a user and triggering programming data download.

Another broad aspect of the present invention is to provide a method for bi-drectional communication between an environment management system controller and an environment management system receiver module, allowing the receiver module to send environment alarm status information to an alarm management module and being abel to retrieve updated control parameters from a server for the environment management system. The method includes the steps of establishing a connection between the system controller and the receiver module in order for the system controller to transmit a message to the receiver module. If the message is a report of environment alarm status information, the receiver module forwards the information to an alarm management module.

### BRIEF DESCRIPTION OF THE DRAWINGS

These and other features, aspects and advantages of the present invention will become better understood with regard to the following description and accompanying drawings wherein:

FIG. 1 is a block diagram of the programming and control system for an environment management system according to one embodiment of the invention;

FIG. 2 is a block diagram of a receiver module according to one embodiment of the invention; and

FIG. 3 is a flow chart of the bi-directional communication protocol between the environment management system and the receiver module according to one embodiment of the invention.

### DETAILED DESCRIPTION OF THE PREFERRED EMBODIMENT

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

The present invention provides a system for remotely programming and controlling, through a web interface, an environment management system such as a security system for fire, intrusion, emergency and access control. The web interface can also be used for programming and controlling a more comprehensive environment management system, including home automation control features. Furthermore, the web interface allows for implementation of a messaging service, allowing for all users associated with an instance of the system to send and receive messages. Messages can also be sent to individuals who are not users of the system, but are subscribing to receive messages.

The environment management system may be controlling an environment such as a residential home, but also a boat, a car, a trailer or any mobile environment.

The web interface allows to modify or create various parameters of the control system and to generate a programming file containing the parameters to transmit to the system. This programming file is kept in memory or in a database until the environment management system communicates to the central server to retrieve the new parameters in the programming file.

The parameters that can be modified or created are contained in at least one form. These forms are displayed in at least one web page.

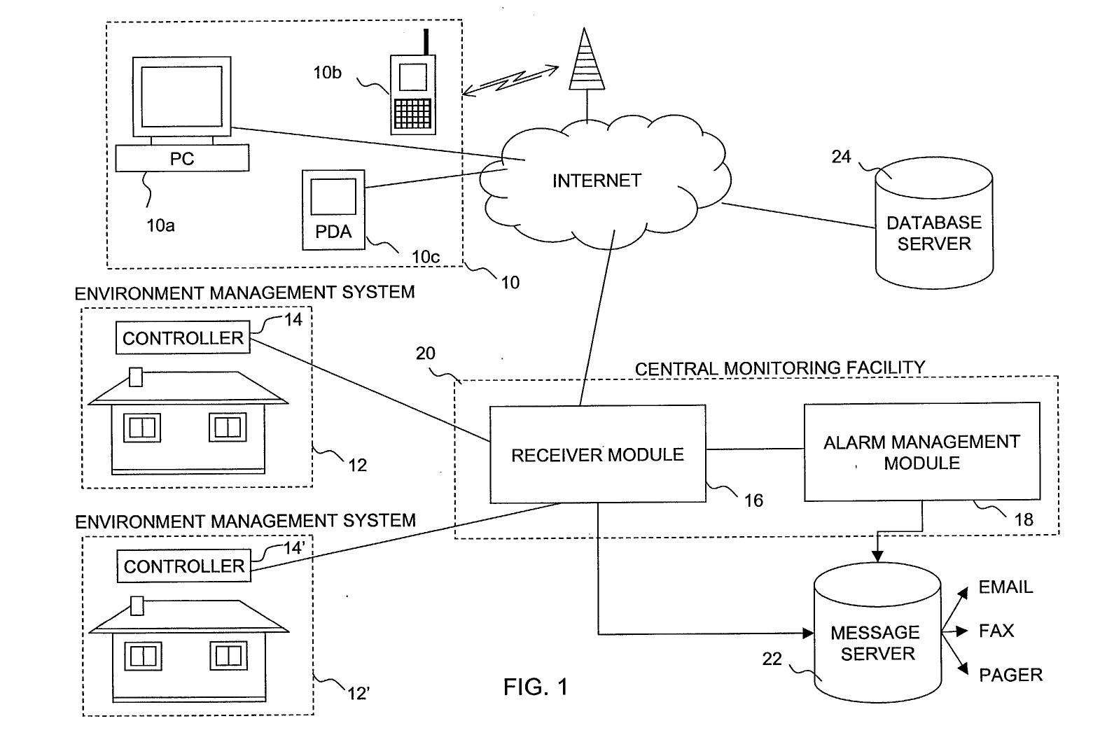

Referring to FIG. 1, the steps of remotely controlling and programming an environment management system will be described. The user will be able to access the system by using any commercially available web browser to address the particular website. An access terminal 10 with web-browsing abilities is provided for creating and modifying parameter values controlling the settings of the environment management system. Such an access terminal may be a web-enabled personal computer 10a, a web-enabled cellular phone 10b or a web-enabled personal digital assistant 10c. Upon requesting the address corresponding to the particular website, a home page is loaded in the browser, corresponding to the entry point to the environment management system account information. The home page contains a username field and a password field for security and authentication purposes. The user will identify himself by providing entries in the two fields and will send the data to the server 24, by clicking on a ‘submit’-type button. Through an SSL conenction, an authentication process takes place on the server side, during which the supplied credentials are checked against a list of authorized users and their respective passwords. If the username and password provided result in an exact match, another page is loaded into the user's browser, displaying information concerning the user's environment management system controller 14. This page contains information about the current status of the environment management system 12, as well as input fields, which can take different parameters. The information the user has access to includes a list of all users associated with a particular environment management system 12, their contact information, as well as a list of types of messages they have subscribed to receive.

The information may be tailored such as to create a user message profile for all users associated with a given environment management system 12. The user message profile is used to decide when and how to broadcast a message initiated by the environment management system 12. Users may select select a preferred language of communication, a preferred type of media of communication, such as e-mail, fax, pager or cellular phone, and the type of message they would like to be notified of, such as alarm reports regarding the arming/disarming of the security ssytem, reports of a fire or a burglary and/or personal messages.

Any environment management system 12 has only one master user and may have none, one or many regular users. The master user may add and/or delete regular users, may change other users' access codes and may choose to selectively transmit messages regarding changes to the environment management system 12 status. Every attempt of modifying the parameter values controlling the environment management system 12 is subject to entering a valid unique master code.

The web interface provided through the access terminal 10 allows modifications to be performed on three different types of services: home security, home automation and a messaging service. In the home security area of the website, the fields displayed take parameters controlling features such as global arming/disarming of the security system of the environment management system 12, specification of entry/exit delays, selection of bypass zones and other special features, such as door chime, alarm sound characteristics, etc. On the home automation page, the various home devices connected to the environment management system 12, such as interior and exterior lighting, electric plugs, pool filter, remote car starter can be programmed. Additionally, on the messaging service page, fields allow for specific messages to be sent to any of the subscribing users.

As the user enters parameters in each of the fields of interest, the information is validated by the entry fields of the form, to ensure that it is within a range of acceptable values. When the user has finished entering the information, by clicking on a ‘submit’-type button the information entered in the form is sent to a database server 24. If the access terminal provides a web-based interface, database server 24 is an HTML server. The information is again compiled and a secondary validation of the information entered in the form is performed. During this second validation, the data that could not be simply validated by the form is validated. In the preferred embodiment, if all the information has been validated, a programming file is created, containing the values of the parameters and the subroutines necessary to program the environment management system controller 14. The programming file contains the programming data, which is a translation into system-specific code, so that it may be transmitted and used by the environment management system to modify and create parameters as defined by the user during the web session. The programming data gathered and stored in the programming file is associated with an identification code. At the end of the web programming session, the user is provided with the identification code which is to be used in the request for download of the newly created programming file into the environment management system 12.

In an alternative embodiment, database server 24 storing the HTML files and the programming files to be downloaded could be integrated into the environment management system 12.

In a different embodiment, the parameter values created or modified by the user during the web session may be stored as programming data, without being translated into system-specific code. In that case, the environment management system 12 will have to process and translate the programming data into system-specific code, before using it to modify its control settings.

Alternatively, the programming file available for download may be a software upgrade of the environment management system controller 14.

The programming file will be stored in the memory of a database server. The file will be transmitted to the environment control system during an upload/download session. The transmission will take place over a data link, which could be a telephone link, direct data link or a wireless link.

The programming file can either be transmitted directly to the environment management system 12 or can be stored until a request from the environment management system controller 14 is sent to the database server 24. In both cases, a download session must be initiated by the environment management system controller 14 for the transmission to take place. As soon as a download is triggered, the programming file is sent to the environment management system controller 14 via a data link.

The transmission does not take place directly between the database server and the environment control system, but rather through a receiver module 16. In the preferred embodiment, there are three ways of triggering the transmission of a programming file between the database server 24 and the environment management system controller 14.

A triggering means for authenticating a user and triggering download of the programming file is, in the preferred embodiment, a special upload/download touch-key or a predefined key sequence on the control panel associated to the environment management system 12. Pressing the upload/download key, followed by entering the master code will initiate a call to the receiver module 16, in order to establish a connection. In a different embodiment, the upload/download key might be a physical key that the user may insert into an appropriate slot in the control panel associated to the environment management system 12, in order to trigger the download of the programming file.

For this triggering means, once the connection between the environment management system controller 14 and the receiver module 16 is established, the environment management system controller 14 will send a message to the receiver module 16. The message will include information regarding the identity of the system controller 14, such as a serial code, and a command, such as download request for the programming file and an identification code associated to the file stored on the database server 24. The receiver module 16 will connect to the remote database server 24 storing the programming file, providing the identification code associated with the file. In one embodiment of the invention, the identification code associated with the file may be the same as the serial code of the system controller 14. In another embodiment, the identification code associated with the file is the identification code, generated at the time of modifying and creating the parameter values controlling the environment management system. In that case, the user has to send the identification code through the control system, at the time of requesting the download.

Upon receiving a valid identification code, the programming file is transferred from the database server 24 to the receiver module 16. If the database storing the programming file is remote to the environment of the receiver module 16, the communication between the database server 24 and the receiver module 16 will take place over a TCP/IP communication protocol over the Internet. If the database server 24 storing the programming file is local to the environment of the receiver module 16, a local connection, such as a LAN, will be established and the other steps will be similar.

A second means of triggering the transmission of a programming file and authenticating a user is by calling the environment management system controller 14 from a mobile communication device, such as a cell phone. Since the environment management system controller 14 is connected to the residential phone line, the incoming call may have to bypass an answering machine. The system can be set such that if an incoming call is not answered after a predetermined number of rings, the call will be handled by the environment management system controller 14. Alternatively, the system can be set such that for a first incoming call, the answering machine will be active, but for any following incoming calls within a 30-second time period, the environment management system controller 14 will answer the call. Once the environment management system controller 14 has answered an incoming call, the user is prompted, through a tonality or a voice message, to enter an access code in order to gain access to the functionality of the system. Once the access code has been validated, the user will have to further provide the system with a special sequence of codes, which will have the same effect as pressing the upload/download key. An example is dialing the sequence of keys * 44, followed by the master code.

Yet another way of triggering the transmission of a programming file is by activating the download process from the web site. At the time of submitting new parameter values for the environment management system 12 settings, the user may trigger immediate update, by clicking on a download button. Following the request for loading the updated environment management system 12 settings, the receiver module 16 will connect to the system controller 14. This communication session will allow the receiver module 16 to authenticate itself and to inform the system controller 14 that a programming file is available for download. In a different communication session, the system controller 14 will then connect to the receiver module 16 and will request download of the available programming file.

When the environment management system controller 14 requests transmission of the programming file, the receiving module 16 performs a first authentication step in which it determines if the environment management system 12 is allowed to receive the programming file and if it has the proper software and hardware resources to receive the programming file or to be programmed by the programming file. After this authentication step, if the server does not find any programming file belonging to this environment management system 12, the communication is stopped.

Every time a transmission takes place, a log file is created, containing parameters identifying the type of transactions completed, which environment management system 12 was involved, as well as the date, time and other such parameters concerning the transactions that occurred. This log file is typically accessible to a manager of the web system or to the manager of the receiver module 16.

The environment management system 12 then uses the contents of the programming file to program the system according to the parameters set by the user. For example, the programming file can contain information concerning new access codes, zones to be suspended, users who receive any email when activities are performed by users of environment management system 12, or commands to be executed, such as turning on/off the lights, etc. In another preferred embodiment, the system 12 can receive weather forecast information, lottery numbers, road condition reports, etc.

In parallel, the environment management system 12 has the possibility to send a status report or a personal message to a message server 22. The message server 22 has the possibility to send messages by e-mail, Personal Communication System (PCS) device or Fax to a recipient from a distribution list. The distribution list can be managed through the web interface, similarly to the other parameter control settings of the system 12.

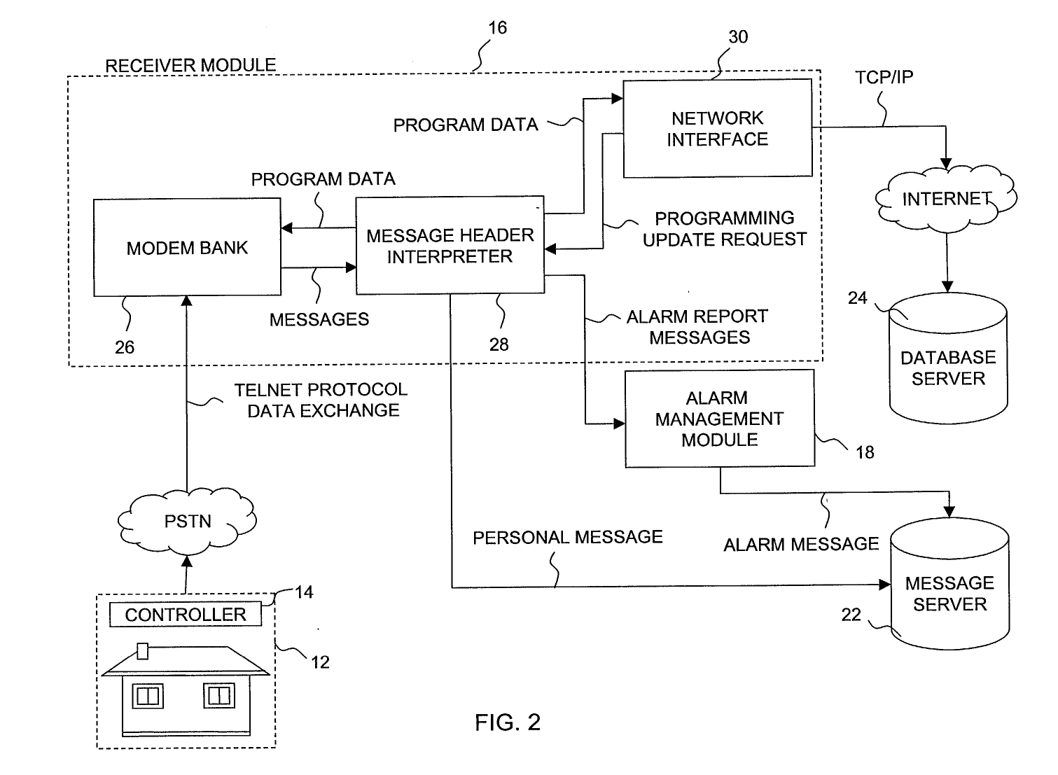

With respect to FIG. 2, the path followed by a message from the environment management system 12 to a recipient will be described. When a monitored device connected to the environment management system 12 detects an unusual event, the environment system controller 14 will attempt to establish a communication link with a receiver module 16. The receiver module 16 is in communication with an alarm management module 18, which is part of a central monitoring facility 20. Upon receiving a report of an unusual event, the central monitoring facility 20 responds according to the type of emergency, by informing the appropriate authorities. In the preferred embodiment, the communication link between the environment management system 12 and the receiver module 16 is modem-based and takes place over a telephone line. The environment system controller 14 uses the communication link to transmit a message, including an alarm report of the exceptional condition detected. The communication link may implement a telnet communication protocol. The controller is one of a plurality of controllers, each associated to a residential or commercial environment management system 12 in a given area, connected to the receiver module 16 and able to send alert messages. In the preferred embodiment, a plurality of system controllers 14 is connected through PSTN telephone lines to a modem bank 26 on the receiver module 16 side. The receiver module 16 allows configuration of parameters for each of the incoming telephone line, such that it may handle different types of connections and different types of system controllers 14. Parameters may include the type of modem used for the communication, the communication protocol, the communication port, transmission of the received message to an alarm management module, etc. Furthermore, for each system controller 14 type supported by the system, the receiver module 16 may be set up to interpret reporting codes and zone information differently. The receiver module 16 interprets therefore the information contained in the incoming message according to the parameter settings and displays it in a human readable format. In a first step, a message header interpreter module 28 decides whether the received message contains a report of environment alarm status information. If such is the case, the alarm report is transmitted to an alarm management module 18, which will respond according to the type of emergency reported. The alarm report may be further transmitted to one or a plurality of recipients, according to their predetermined message profile preferences. In that case, an alarm message will be forwarded to a message server 22 containing information about the possible recipients message profile preferences, such as message transmission means and the type of message notification.

The received message may be a personal message, being one of a plurality of messages preset in the environment system controller 14. If the received message does not contain a report of environment alarm status information, but is a personal message, the message is not transmitted to the alarm management module 18, but is rather sent directly to a message server 22, to be forwarded to one or a plurality of recipients.

The received message may furthermore be one requesting an update of programming data. In the preferred embodiment, such programming data has been gathered and stored in a programming file in a database server during a programming session conducted from a web-enabled access terminal. The receiver module 16 will then establish a connection through a network interface 30 to the database server 24 containing the programming data requested. The connection may be for a communication session implementing a TCP/IP protocol over the Internet or it may be a local LAN connection, if the database server 24 is local to the environment of the receiver module 16. If a programming file containing updated programming data is available, the file is transmitted to the receiver module 16 in the same communication session.

On the receiver module 16 side, all incoming messages, as well as additional information about the system controller 14 may be stored in an SQL relational database. The additional information may include the date and the time of the received message and the serial number of the controller. In an environment in which there are multiple receiver modules set up, the information received by all of these receiver modules may be stored in a database.

### EXAMPLE 1

Events like intrusions or Fire alarm signals can be reported to the receiving module and the receiving module can relay this information to the Web system. The Web system can then send this message to one or more recipients from the distribution list.

### EXAMPLE 2

One can press the Message key on the alarm system keypad, select a predefined message using the keypad and then select one of the recipients form the recipients list, also using the keypad.

A request can also be issued by the control system for uploading information on demand.

### EXAMPLE 3

A request from the control system to receive the object field for all received emails can be made.

The communication between the system controller 14 and the receiver module 16 implements a bi-directional protocol which allows transmitting and receiving data during one data exchange. This protocol is compact and does not require expensive software or hardware resources. It is therefore well adapted to be used in systems based on microprocessors or microcontrollers.

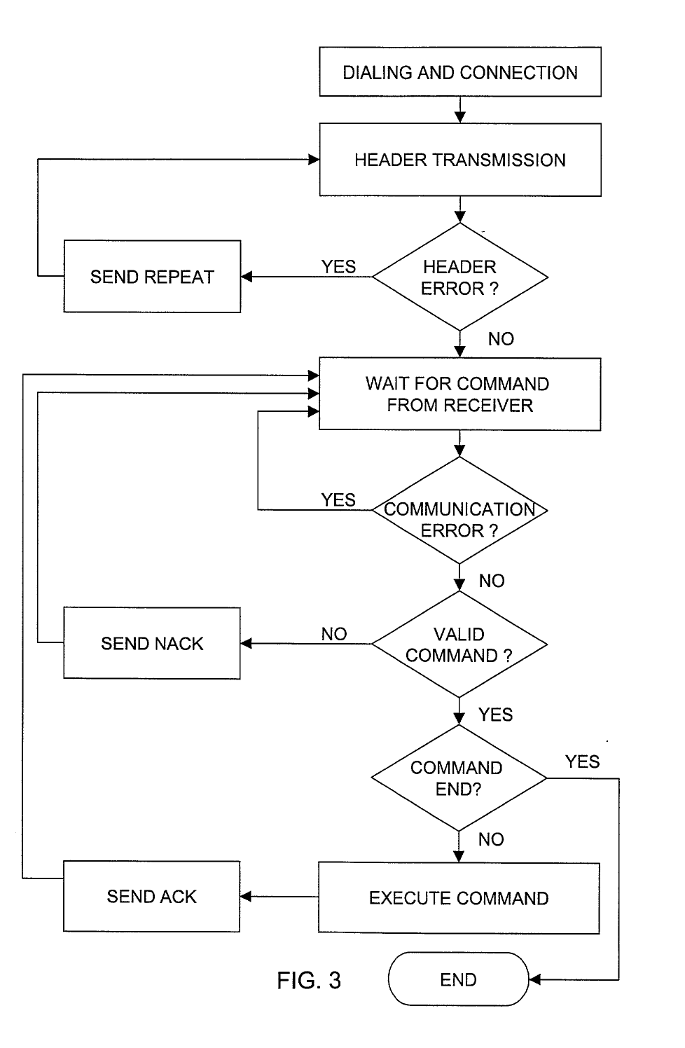

With respect to FIG. 3, the steps of the bi-directionnal protocol of the preferred embodiment will be described. In a first step the system controller 14 dials and connects to receiver module 16. The system controller 14 then proceeds to transmit the header of the message. If there was an error in the transmission of the header, the receiver module 16 sends a repeat command to the system controller 14, asking for the header to be transmitted again. The process is repeated until the header is transmitted error-free. At that point, the system controller 14 waits for a command from the receiver module 16. If there is a communciation error, the command will have to be transmitted again. If the received command is not supported, the system controller 14 will send a NACK back to the receiver module 16. If the command is valid and is not an END command, the command will be executed by the system controller 14 and an ACK will be sent back to the receiver module 16. If the command is an END, the communication will be terminated.

It is preferably used on a modem communication at low speed, which is typical of the basic communication used for environment control systems but could also be used for any speed. The protocol also allows specific commands such as encryption of data. The encryption algorithm can be adapted according to the application or the type of the environment management system 12.

An example of an exchange of information between an environment management system controller 14 which communicates with the receiving module of a web system will now be described. In a first step, the remote environment control system calls a receiver module 16 in order to establish a communication link. In the case of a modem communication on a telephone link, the system controller 14 takes a line, dials the telephone number of the receiver module 16 and prepares the connection with an exchange of the carrier information. In the case of a direct communication, for example, on an RS 232 port, this step is not required. As soon as the connection is established, the system controller 14 transmits the header of the message, comprising preferably ten elements. These elements are the encryption type, the error verification type, the communication mode, the header format, the system controller 14 type, the software version, the hardware version, the communication format, the reason for the call and the identification number of the system controller 14. The header is transmitted only once even if there are many types of commands during a single exchange.

After transmission of the header, the system controller 14 waits for a command from the receiver module 16. If the receiver module 16 has received the header and no errors have been detected, the communication can continue. If there has been an error in the message received, the receiver module 16 can request that the system controller 14 repeat the message. If there are further errors, the receiver can decide to disconnect the call by sending a “NACK”+“END” command or by canceling the communication link.

The receiver module 16 then verifies in the header information whether the reason for the call is valid and if it is supported. If the request is supported by the receiving module 16, the process continues. If the command is not supported by the receiver module 16, the receiver sends a “NACK” to the system controller 14. The system controller 14 must then resubmit its request or, depending on the internal logic of the system controller 14, can decide to end the call or disconnect the communication.

If the command received is an end-of-call command, the receiver and the system controller 14 end the communication. Otherwise, if the command received from the system controller 14 is valid, it will be executed by the receiver module 16. After execution of the command by the receiver module 16, an “ACK” message is returned to the system controller 14, together with a command number. The exchange between the system controller 14 and the receiver module 16 continues if there are other commands to execute, otheriwse the connection is terminated.

At any point during this data exchange, the receiver module 16 can request that the system controller 14 change its mode into a download mode to be able to receive data, such as a programming file, from the receiving module.

The following commands are supported by the protocol:

TABLE 1
Commands supported by protocol

Send Alarm
Upload
Upload with AND, OR logical operation.
Download
Ack
Nack
Repeat
End of Alarm
End of Message
Enquiry
End

To these commands, a few others can be added for more functionality:

TABLE 2
Additional Commands supported by protocol

Total Message Length, including Header and Checksum/CRC
Message length
Message type
Message format
Data type, (string, binary, time, date . . . )
Checksum or CRC
Half/Full Duplex
System controller type
System controller ID or serial number
Zone
Reporting Code
Memory type (target)
Start Address, (High order byte)
Start Address (Low order byte)
Number of consecutive data bytes to write
Number of consecutive data bytes to read
Parameter Length Start Address, (High order byte)
Parameter Length Start Address (Low order byte)
Parameter type
Hardware version
Software version
Call type
Message format
Encryption

The transfer of information is done to write, modify or read information contained in different memory units of the system controller 14. The transfer can be done in two ways: Upload, where the receiver module 16 transfers information to the system controller 14 and Download, where the system controller 14 sends information to the receiver module 16.

To read information from the system controller 14, the receiver module 16 specifies with which type of memory it wishes to communicate. Memory types can be PROM, EPROM, FlashROM, RAM, FRAM. Then, the receiver module 16 specifies the 2-byte beginning address and the number of bytes it wishes to receive from the system controller 14. If there are more than 256 bytes to receive, the receiver module 16 can make multiple requests by changing the beginning address. There is no limit to the total number of bytes which can be read in one particular communication exchange.

To write information to the system controller 14, the receiver module 16 specifies the type of memory with which communication will take place, the 2-byte beginning address of the memory location, the number of bytes to be written, followed by the data.

In the two types of transactions, if the system controller 14 does not support one of the commands requested by the receiver module 16 or if the system controller 14 does not have the type of memory specified by the receiver module 16, or any other error, the system controller 14 will respond with a Not Supported.

In some cases, it might be necessary to do logical operations to change the state of one or more bits in a byte of memory of the system controller 14, without changing the state of the other bits. This type of operation can be done by a succession of downloads and uploads and is relatively long to achieve if it must be done on many bytes. To simplify this operation, there is an AND, OR mode which allows logical operations to be carried out. The structure of that operation is detailed in the next pages.

The length of the bidirectional protocol is variable, depending on the type of message.

Short Format:

[ML][MT] [DA][DA] . . . [DA] . . . [CSCRC]

M=Total length of the message which starts all the bytes, even the CRC/Checksum.

MT=Message type (the 8^{th} bit is reserved for ACK/NOACK).

DA=Data of the message

CSCRC=Checksum or CRC

NOTE: The 8th bit of the MESSAGE TYPE (MT) is reserved to send an ACK or a NOACK in response to the previous message. (ACK=80H, NOACK=00H)

Defined Messages Types (MT) for the short format:

TABLE 3
Defined message types for the short format protocol.

| Value | Definition |
|---|---|
| 00 | NACK (Bit 7 = 0) |
| 01 | Header |
| 02 | SA (Send Alarm) |
| 03 | Upload |
| 04 | Download |
| 05 | Upload or And |
| 124 | Not supported |
| 125 | Inquiry |
| 126 | End |
| 128 | ACK (Bit 7 = 1) |
| 05 . . . 123 | Not defined |

Long Format:

[MLH][MLL] [MT] [PLH][PLL][PT][DT] [DA][DA] . . . [DA] [PT][DT][PLH][PLL] [DA][DA] . . . [DA] . . . [CSCRC]

MHL,MLL=Total length of the message which starts all the bytes, even the CRC/Checksum.

MT=Message type

PLH,PLL=Length of the parameter which starts on the first byte of data and which ends on the last.

PT=Parameter type.

DT=Type of Data (String, Binary, Date, Hour . . . )

DA=Data of the parameter

CSCRC=Checksum or CRC

Header Formats (Message type 01):

[PR][CAT][VERS][VERH][FB][AP1][AP2][AP3][AP4]

The header is sent only once, at the beginning of the communication, but the receiver module 16 can request the header at anytime during a call if needed.

PR=Protocol:

(D7,D6=Encryption Type (00=No encryption))

D5=CRC (1) or CHECKSUM (0)

D4=Half Duplex Interface (0) Full Duplex Interface (1)

D3..D2=Header Formats

D1..D0=Not used

CAT=Apparatus Category

VERS=Apparatus Software Version

VERH=Hardware Version

FB=communication Format+Initial Goal of the call

D7..D5=Communication format used by the apparatus

D4..D0=Goal of the call

AP1, AP2, AP3, AP4=Apparatus number in BDC format nibble coded. AP1 is the strongest byte.

PROTOCOL BYTE (PR):

TABLE 4
Protocol Byte

| | Values | Definitions |
|---|---|---|
| Encryption (D7 . . . D6) | 00 | No encryption |
| | 01 | Not defined |
| | 10 | Not defined |
| | 11 | Not defined |
| Checksum/CRC (D5) | 0 | Checksum |
| | 1 | CRC |
| Half/Full Duplex (D4) | 0 | Half Duplex |
| | 1 | Full Duplex |
| Header Formats (D3 . . . D2) | 00 | Complete (PR, CAT, VERS, |
| | | VERH, FB, AP1, AP2, AP3, |
| | | AP4) |
| | 01 | Not defined |
| | 10 | Not defined |
| | 11 | Not defined |
| Not used (D1 . . . D0) | — | Not used |

Apparatus Categories (CAT):

TABLE 5
Apparatus Categories

| Values | Definitions |
|---|---|
| 00-09 | Reserved |
| 10 | V6 |
| 11 | V7 |
| 12 | Proprietary apparatus |
| 13 | Proprietary apparatus with Domotics |
| 14-255 | Not defined |

software Version (VERS):

Version of the software programmed in the apparatus. EX: A, B, C, . . . in ASCII

hardware Version (VERH):

Version of the PCB used in the apparatus. EX: A, B, C . . . in ASCII

Apparatus number (AP1, AP2, AP3, AP4):

Apparatus number in BCD format, 2 digits per byte and therefore 8 in total. AP1 is the byte with the strongest weight.

communication Formats+Initial goal of the call (FB):

TABLE 6
Communication Formats

| | Values | Definitions |
|---|---|---|
| Communication Format. | 00 | Short proprietary format |
| (D7 . . . D5) | 01 | Long proprietary format |
| | 02-07 | Not defined |
| 1.1 Call Goal (D4 . . . D0) | 00 | Alarm |
| | 01 | Upload/Download |
| | 02 | Banking Transactions |
| | 03-31 | Not defined |

Header Example:

No encrytion

Utilizes a CRC

Half Duplex Interface

Complete Header Format

Apparatus Catagory: Proprietary apparatus

Version software=A

Version hardware=A

Communication Format=Short proprietary format

Initial Call Goal=Transmission of alarms

Apparatus Number=00123456

FA=0 Format of alarm 0.

MT=00 (Transmission of alarms)

#App=123456

HEADER: [PR][CAT][VERS][VERSH][FB][AP1][AP2][AP3][AP4] [20][ 0C][ 41][ 41][00][ 00][ 12][ 34][ 56]

Alarm Messages format 0 (message type 02):

[FA][RCODE][ZONE][EOM] or [EOA]

FA=Alarm Message format

RCODE=Reporting Code

ZONE=Zone

EOM=End of message (80h) or

EOA=End of alarm (84h) More alarms are to be transmitted in this call.

### EXAMPLE

FA=0 Alarm format 0.

#App=123456 (previously transmitted in the header)

RCODE=3

ZONE=5

MSG: [00][03][05][80]

[DA][DA][DA][DA]

Protocol for Upload/Download (Message type 03, 04, 05):

upload command (03):

Transfer of data from the receiver module 16 to the system controller 14 (write).

Request:

[TM][ADH][ADL][CNT] [DA][DA] . . .

TM=Memory type specific to each system controller

ADH=High address for the beginning of the write operation

ADL=Low address for the beginning of the write operation

CNT=Number of bytes to write

DA=Data sent by the computer

Reply:

If the command is valid, the system controller 14 replies with an ACK. If it isn't, it replies with a NACK or a “not supported”.

### Example 1

System Controller with Memory Types=FRAML(0), FRAMH(1).

Upload 8 bytes from address 20H in the FRAML with CRC.

[TM][ADH][ADL][CNTH][DA][DA][DA][DA][DA][DA][DA][DA]

[00][ 00][ 20][ 08][00][01][02][03][04][05][06][07]

### Example 2

System Controller with Memory Types=FRAML(0), FRAMH(1).

Upload 5 bytes from address 45H in the FRAMH with CRC.

[TM][ADH][ADL][CNTH][DA][DA][DA][DA][DA]

[01][ 00][ 45][ 05][05][04][03][02][01]

download command (04):

Transfer of data from the system controller 14 to the receiver module 16 (read).

Request:

[TM][ADH][ADL][CNT]

TM=Memory type specific to each apparatus

ADH=High address for the beginning of the read operation

ADL=Low address for the beginning of the read operation

CNT=Number of bytes to read

### Example 1

System Controller with Memory Type=FRAML(0), FRAMH(1).

Download 8 bytes from address 20H to the receiver module 16 with CRC.

[TM][ADH][ADL][CNTH]

[00][ 00][ 20][ 08]

Response:

The system controller 14 responds by providing the bytes requested.

Response (the FRAML contains 0xFF from the requested address)

[D1][D2][D3][D4][D5][D6][D7][D8]

[FF][FF][FF][FF][FF][FF][FF][FF]

Upload OR AND Command (05):

Performs “OR” and “AND” bitwise operations with data sent from the receiver module 16 to the memory of the system controller 14 (write).

Request:

[TM][ADH][ADL][CNT] [DA][DA] . . .

TM=Memory type specific to each system controller

ADH=High address for the beginning of the writing operation

ADL=Low address for the beginning of the writing operation

CNT=Number of bytes to write.

OR=“OR” Mask sent by the computer on the number of bytes sent

AND=“AND” Mask sent by the computer on the number of bytes sent

Response:

If the command is valid, the system controller 14 replies with a ACK. If it is not, it replies with a NACK or a “not supported” message.

### Example 1

System Controller with Memory Type=FRAML(0), FRAMH(1).

UploadOrAnd 4 bytes from address 20H n the FRAML with CRC.

(contents of 32H or 01H, contents of 20H and EFH),

contents of (21H or 02H, contents of 21H and FDH) etc. . . .

[TM][ADH][ADL][CNTH][OR][AND][OR][AND][OR][AND][OR][AND]

[00][ 00][ 20][ 04][01][EF] [02][FD] [04][FB] [08][7F]

### Example 2

System Controller with Memory Type=FRAML(0), FRAMH(1).

UploadOrAnd 1 byte from address 45H in the FRAMH with CRC.

(contents of 45H or 01H, contents of 45H and 10H),

[TM][ADH][ADL][CNTH][OR][AND]

[01][ 00][ 45][ 01][10][FE]

Complete example of Upload/Download:

The steps of the upload/download communication, in chronological order, are as follows:

1. The system controller 14 calls the receiver module 16 and establishes the connection.

2. The system controller 14 sends the protocol header with the following data:

No encryption

Uses a CRC

Half Duplex Interface

Complete Header Format

Apparatus Category: Proprietary apparatus

Version software=A

Version hardware=A

Communication Format=Short Format

Initial Call Goal=Upload/download

Apparatus Number=00123456

3. The receiver module 16 requests a download of 5 bytes from address 45H.

4. If there is a communication error, the apparatus did not understand the command and waits for another command.

5. The computer sends the last command again

6. The apparatus responds with the download response and sends the following bytes: 01, 02, 03, 04, 05

7. The user changes the parameters in the panel programming module of the apparatus which takes about 35 seconds.

8. After an idle period of about 15 seconds, the computer sends a ENQ to signal its presence to the panel.

9. The apparatus responds with a ACK

10. After another 15-second idle period, the computer sends a ENQ to signal its presence to the panel.

11. The apparatus responds with a ACK

12. The computer requests a upload of 8 bytes from address 32H in the FRAML with the following bytes: 00, 01, 02, 03, 04, 05, 06, 07.

13. The apparatus responds with a ACK

14. The computer has completed its upload/download and sends a ACK(END) to complete the call

15. The apparatus terminates the call.

1. Call and connection

2. P [ML][MT][PR][CAT][VERS][VERH][FB][[AP1][AP2][AP3][AP4][CSRC]

[0D][01][20][OC] [41] [41] [01] [ 00][ 12][ 34][ 56][AA][B1] Header

3. O [ML][MT][TM][ADH][ADL][CNTH][CSCRC]

[08][84][01][ 00][ 45][ 05][73][FB] Download 5 byte at 45H

4. P communication error, the apparatus waits for a new command

5. O [ML][MT][TM][ADH][ADL][CNTH][CSCRC]

[08][84][01][ 00][ 45][ 05][73][FB] repeat download 5 bytes at 45H

6. P [ML][MT][DA][DA][DA][DA][DA][CSCRC]

[09][84][01][02][03][04][05][A1][4F] download response

7. O parameter change

8. O [ML][MT][CSCRC]

[04][FD][96][0F] ENQ

9. P [ML][MT][CSCRC]

[04][80][9C][0F] ACK

10. O [ML][MT][CSCRC]

[04][FD][96][0F] ENQ

11. P [ML][MT][CSCRC]

[04][80][9C][0F] ACK

12. O [ML][MT][TM][ADH][ADL][CNTH][DA][DA][DA][DA][DA][DA][DA][DA][CSCRC]

[10][83][00][ 00][ 20][ 08][00][01][02][03][04][05][06][07][7A][60] Upload

13. P [ML][MT][CSCRC]

[04][80][9C][0F] ACK

14. O [ML][MT][CSCRC]

[04][FE][1A][0C] END

15. P End call

O End call

It should be noted that the present invention can be carried out as a method, can be embodied in a system, a computer readable medium or an electrical or electromagnetic signal.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

What is claimed is:

1. A programming and control system for remotely programming and controlling an environment management system comprising:
an access terminal for at least one of creating and modifying a modifiable parameter value controlling said environment management system;
a server in communication with said access terminal for gathering and storing programming data corresponding to said modifiable parameter value and associating said programming data with an identification code;
an environment management system receiver module for receiving said programming data from said server;
an environment management system controller connectable to said receiver module, providing said identification code and receiving said programming data from said receiver module;
a triggering means in communication with said system controller for authenticating a user and triggering said programming data download;
whereby said programming data corresponding to said modifiable parameter value is gathered and stored on said server and in a different communication session, said triggering means sends a request for said programming data to said receiver module, such that said receiver module communicates with said server and retrieves said programming data.

2. The system according to claim 1, wherein said access terminal is a web-enabled personal computer.

3. The system according to claim 1, wherein said system controller and said receiver module are connected through a modem dial-up connection.

4. The system according to claim 1, wherein said system controller is one of a plurality of environment management system controllers connectable to said receiver module.

5. The system according to claim 4, wherein said identification code corresponds to exactly one of said system controllers.

6. The system according to claim 1, wherein said receiver module is one of a plurality of receiver modules in communication with said server.

7. The system according to claim 1, wherein said triggering means comprises a key input on said environment management system.

8. The system according to claim 7, wherein said authentication means is a mastercode to be introduced on said keypad control panel by said user.

9. The system according to claim 7, wherein said authentication means is a physical key to be inserted in a slot in said keypad control panel by said user.

10. The system according to claim 1, wherein said modifiable parameter value is an update of security system settings.

11. The system according to claim 1, wherein said modifiable parameter value is an update of home automation settings.

12. The system according to claim 1, wherein said server performs validation on said modifiable parameter value.

13. The system according to claim 1, wherein said programming data is an upgrade software for said system controller.

14. The system according to claim 1, wherein said controller has direct dial-up ability to connect to said server for requesting said programming data.

15. The system according to claim 1, wherein said server is part of the environment management system.

16. A method for bi-directional communication between an environment management system controller and an environment management system receiver module, comprising:
establishing a first connection between said system controller and said receiver module;
said system controller transmits a message to said receiver module;
if said message contains a report of environment alarm status information, said receiver module relays said information to an alarm management module;
if said message contains a request for updated programming data, said receiver module establishing a second connection to a server storing said updated programming data;
if said updated programming data is available, said receiver module retrieves and transmits said updated programming data to said controller.
whereby said receiver module is able to relay said environment alarm status information to an alarm management module and is able to retrieve from said server updated control parameters for the environment management system.

17. The method of claim 16, further comprising the step of said receiver module forwarding said message information to a message server to be broadcast to at least one of a plurality of predetermined user-defined communication devices according to user-set preferences.

18. The method of claim 17, wherein said at least one of user-defined communication devices is a cellular phone.

19. The method of claim 16, further comprising the step of said receiver module interpreting said message data received from said system controller such that it may communicate over a different communication protocol link with said server.

20. The method of claim 16, wherein said first connection allows a communication session based on a telnet protocol.

21. The method of claim 16, wherein said second connection allows a communication session based on a TCP/IP protocol.

22. The method of claim 16, further comprising the step of said receiver module performing error checking on said updated programming data retrieved from said server.
